(19) United States
(12) Patent Application Publication
(10) Pub. No.: US 2014/0004922 A1
(43) Pub. Date: Jan. 2, 2014

(54) System for Detecting Unauthorized Movement of a Lottery Terminal

(71) Applicant: Scientific Games International, Inc., Newark, DE (US)

(72) Inventor: William F. Behm, Roswell, GA (US)

(21) Appl. No.: 13/932,424

(22) Filed: Jul. 1, 2013

Related U.S. Application Data
(60) Provisional application No. 61/667,129, filed on Jul. 2, 2012.

(51) Int. Cl. G07F 17/32

(52) U.S. Cl. CPC G07F 17/329
USPC 463/17

(57) ABSTRACT

A lottery terminal includes a housing and a terminal controller configured within the housing for processing a player's request for a lottery ticket via an input device and issuing an authorized lottery ticket to the player via an output device. A network interface communicatively couples the terminal controller to a lottery authority network. A motion sensor is operably configured within the housing to detect movement of the lottery terminal from a stationary position. The motion sensor is in communication with the terminal controller, which may be further configured to transmit a signal to the lottery authority network indicating movement of the lottery terminal beyond a threshold value.

### RELATED APPLICATION

The present application claims priority to U.S. Provisional Application Ser. No. 61/667,129, filed Jul. 2, 2012.

### FIELD OF THE INVENTION

The present invention relates generally to lottery terminals, such as a lottery terminal for issuing on-line lottery tickets, and more particularly, to a lottery terminal configured with a device for detecting and generating a signal in response to unauthorized movement of the terminal.

### BACKGROUND

Various state and other jurisdictional entities typically administer on-line lottery games wherein players purchase lottery tickets at an authorized point-of-sale (POS) location, such as a retail establishment that is authorized to sell lottery tickets. One or more lottery terminals are located at these POS locations and are connected to the lottery authority's central computer system for various control purposes. Players may request a lottery number (or have a lottery number randomly generated for them), wherein a corresponding lottery ticket is generated by the lottery terminal. The transaction, lottery number, security codes, and any other manner of information related to sale and purchase of lottery tickets via the lottery terminals are monitored and recorded by the lottery authority.

The physical location of the individual lottery terminals is a closely controlled parameter. Often, the lottery terminals are only allowed at a particular location within a retail establishment, for example at or near the check-out counter. The lottery terminals may not, in certain jurisdictions, be located in certain types of retail establishments, or near areas in an establishment that are also attractive to minors. Once authorized for a particular retail establishment, a lottery terminal is generally not to be relocated to another establishment without express authorization from the lottery authority.

It should thus be appreciated that unauthorized movement of a lottery terminal is an ongoing concern for a lottery authority for any one or combination of reasons. The present invention provides a means to retrofit existing terminals and outfit new terminals with a cost-efficient and reliable system for warning a lottery authority of unauthorized movement of a lottery terminal, wherein the lottery authority may take any manner of responsive action.

### SUMMARY

Objects and advantages of the invention will be set forth in part in the following description, or may be obvious from the description, or may be learned through practice of the invention.

In one embodiment in accordance with aspects of the invention, a lottery terminal is provided with a housing and a terminal controller configured within the housing for processing a player's request for a lottery ticket. The lottery terminal may be configured with any manner of input device for entering the player's request, as well as any manner of output device for issuing an authorized lottery ticket to the player. The lottery terminal is communicatively coupled to a lottery authority network via a network interface. The lottery terminal is equipped with a motion sensor within the housing to detect movement of the lottery terminal from a stationary position. The motion sensor is in communication with the terminal controller, which is further configured to transmit a signal to the lottery authority network indicating movement of the lottery terminal beyond a threshold value.

In certain embodiments, the motion sensor may be an accelerometer device, and may be equipped with a timing device for generating a time stamp that marks the beginning and end of the motion event, which may be stored in a memory in the terminal controller for later transmission to the lottery authority network.

In other embodiments, the motion sensor and terminal controller may be configured for generating a magnitude value for particular movement events. For example, the terminal controller may be configured to calculate a gravitational force loading (G force) for the detected movement of the lottery terminal over the time-stamped period.

The terminal controller may be configured to generate different command signals for the lottery terminal responsive to degrees of motion detected by the motion sensor. For example, the terminal controller may generate a shutdown command signal responsive to detected motion above a threshold value to disable the lottery terminal. The terminal controller may generate and transmit to the lottery authority network any combination of an alert signal, corrective action signal, or service call request based on detected motion of the lottery terminal.

In still other embodiments, the command signals may be generated by the lottery authority network and transmitted to the terminal controller in response to signals received from the terminal controller indicating movement of the lottery terminal.

It may, in certain embodiments, be desired to provide a battery backup to the motions sensor and/or related command functions so that the functions cannot be overridden by disconnecting power from the lottery terminal.

The present invention also encompasses various embodiments of a lottery terminal system wherein a plurality of the lottery terminals as discussed above are communicatively coupled to the lottery authority network. The lottery terminals may include any combination of the features and aspects described above and discussed in greater detail herein.

Additional aspects of the methodology and system are discussed in greater detail below by reference to particular non-limiting embodiments illustrated in the drawing.

### BRIEF DESCRIPTION OF THE DRAWINGS

FIG. 1 is a perspective view of a lottery terminal with a motion sensor in accordance with aspects of the invention;

FIG. 2 is a perspective view of another embodiment of a lottery terminal with a motion sensor; and

FIG. 3 is a block diagram of exemplary electronic components of a lottery terminal system in accordance with aspects of the invention.

### DETAILED DESCRIPTION

Reference will now be made in detail to embodiments of the inventive methods and systems, one or more examples of which are illustrated in the drawings. Each embodiment is presented by way of explanation of the invention, and not as a limitation of the invention. For example, features illustrated or described as part of one embodiment may be used with another embodiment to yield still a further embodiment. It is intended that the present invention include these and other modifications and variations as come within the scope and spirit of the invention.

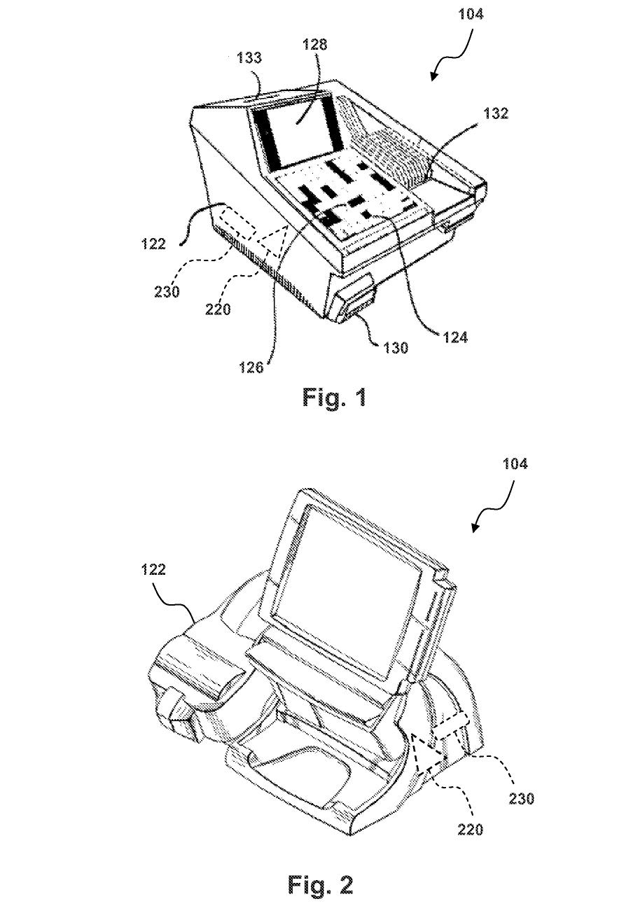

FIGS. 1 and 2 are views of conventional lottery terminals 104 that may be configured with a motion sensor 200 to detect movement of the lottery terminal 104. As discussed above, it is desirous to detect unauthorized movement of the lottery terminal 104 for various reasons. In general, the “lottery terminal” is a machine provided at a point-of-sale (POS) for the authorized distribution of lottery tickets, for example at or near the check-out location of a retail establishment. Although the following description relates to the design of a lottery terminal unit 104 in general, it should be understood that the lottery terminal units 104 within the scope of the present invention may vary widely in design, appearance, and functionality. For example, the lottery terminal 104 depicted in FIG. 2 is a “WAVE” lottery terminal provided by Scientific Games Corp., which has significantly different features and functionalities as compared to the more conventional lottery terminal 104 depicted in FIG. 1.

In general, the lottery terminals 104 include a housing or casing 122, and one or more input and output devices, which may be, among other things, a control panel 124 having a plurality of input keys 126, a display 128, a value input device such as a card reader 130, a lottery play slip or ticket reader 132, and a lottery ticket printer 133. The lottery play slip reader 132 may be configured to read bar codes, user selections, magnetically stored information or any other desired input information or media used to encode information on a play slip or lottery ticket. The input keys 126 may allow the player or sales agent to select the game to be played, input the value to be wagered, manually enter the selected lottery characters, and input any other information necessary to play a given lottery game. The display 128 may be a LCD, a CRT, a touch-screen capable of receiving and displaying information, or any other suitable device capable of displaying the information input via the input keys 126, the lottery play slip reader 132 or the touch-screen input. The value input device may include any device that can accept value or a wager from a customer, such as the card reader 130 or an optical currency collector. The value input device may further be integrated with external devices, such as cash registers or other retail terminals, communicatively connected to the lottery terminal unit 104, to exchange information necessary to receive and record the wagering transactions. The lottery ticket printer 133 may be used to print or otherwise encode lottery tickets with information selected or required to play a given lottery game. Further, the lottery ticket printer 133 may provide lottery tickets, or even completed lottery slips if the selections were generated automatically, that could be used by the player in other lottery terminal units 116 equipped with lottery play slip or ticker readers 132.

Moreover, the lottery terminal units may include centralized or shared display mechanisms such as a scrolling digital signs or messaged boards configured to display the outcome of a completed lottery game and advertises or attract players to upcoming games. In one exemplary configuration, at least one lottery terminal unit 104 includes software for generating graphics and is communicatively connected to an external LCD suitable for displaying graphics. Upon completion of a lottery drawing, the results or winning information can be formatted by the graphical software and displayed, in an eye-catching manner, on the external LCD. Alternatively, the graphical software may be stored on a peripheral device, such as a CD-ROM, and the result of the lottery drawing communicated thereto for formatting and display.

The lottery terminals 104 are equipped with a motion sensor 220 disposed within the housing 122 to detect movement of the lottery terminal 104 from a stationary position. Various types of commercially available motion sensors may be used for this purpose. In a particular embodiment, the motion sensor 220 is an accelerometer device, such as a micro electro-mechanical system (MEMS). These devices may consist of a cantilever beam with a proof mass (also referred to as a seismic mass). Under the influence of an external acceleration, the proof mass deflects from a neutral position. The deflection is measured in an analog or digital manner. Typically, the capacitance between a set of fixed beams and a set of beams affixed to the proof mass is measured, typically along three axes. An example of this type of accelerometer is the LIS302DL linear accelerometer available from ST Microelectronics. This device is programmable to generate an output signal when an acceleration threshold is exceeded in at least one of three axes. This output signal may be used to initiate any manner of control function associated with the lottery terminal 104, including shutdown of the terminal.

The motion sensor 220 may also be a spring-based system wherein piezo-resistors are integrated with the springs to detect deformation of the springs resulting from movement-based acceleration of the lottery terminal 104.

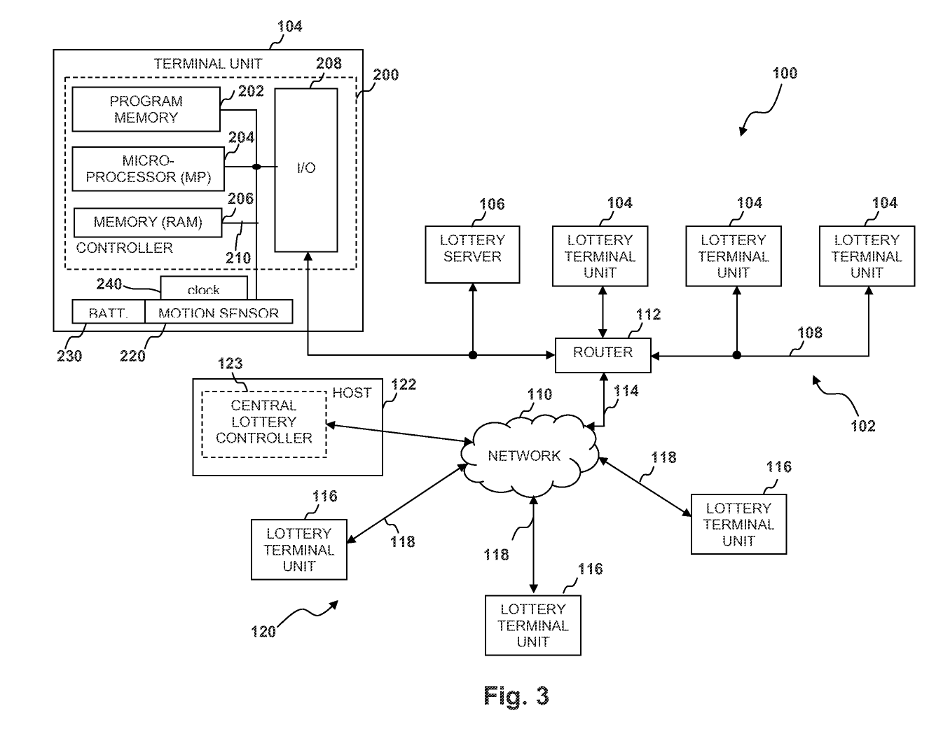

Referring to FIG. 3, a block diagram of selected portions of one possible embodiment of a lottery terminal 104 is provided. The exemplary lottery terminal unit 104 may include a number of internal components such as a controller 200 having a program memory 202, a microcontroller or microprocessor (MP) 204, a random access memory (RAM) 206, and an input/output (I/O) bus 208, all of which may be interconnected via an address or data bus 210. It should be understood that while only one microprocessor 204 is shown herein, the controller 200 may be designed to support multiple microprocessors 204 arranged to operate in parallel or in any other known configuration. Similarly, the controller 200 may include multiple, and even redundant, program memories 202 and random access memories 206 to increase expandability, capacity and/or processing speed.

The multiple processor and memory configurations may be used, for example, to isolate the individual lottery functions such as basic lottery operation, random number generation, information tracking, and the like from various voting functions such as voter identification, tracking of voter selections, and more. Although the I/O bus 208 is shown as a single addressable and integral block, it should be understood that direct I/O connections may be made, as well as any other desired I/O connection scheme.

The program memory 202 and random access memory 206 may be implemented as a solid-state memory, an integrated circuit, a magnetically readable memory, and/or optically readable memories. Further, the program memory 202 may be read only memory (ROM) or may be read/write memory such as a hard disk. In the event that a hard disk is used as the program memory, the data bus 210 may comprise multiple address/data buses, which may be of differing types, and there may be a separate I/O circuit between the data buses.

Additional discussion of how lottery terminal units 104 may function is provided in U.S. Pat. No. 7,134,959 (Penrice) and U.S. Pat. No. 7,204,756 (Jubinville et al.), both of which are incorporated herein by reference for all purposes.

Both memory units 202, 206 can generally be considered as data stores, which may be selectively employed to implement lottery and detected motion functionalities in accordance with aspects of the present technology. For example, program memory 202 may be used to store software in the form of computer-readable instructions and executable instructions that are configured to program the controller 200 as a special purpose computing device to perform various algorithmic steps related to the control functions responsive to detected motion events. Memory 206 or other data store may be configured to temporarily or permanently store input and other electronic data received from the motion sensor 220.

Still referring to FIG. 3, the motion sensor 220 is in communication with the terminal controller 200, which receives the output signal from the sensor 220 for initiation of any one or combination of control functions, which may include transmission of a corresponding signal to a lottery authority network (discussed in greater detail below) indicating movement of the lottery terminal 104 beyond a threshold value. It should be appreciated that this “threshold value” may be any detected movement of the lottery terminal 104. A timing device 240, such as a clock, may be integrated with the controller 200, for example with the microprocessor 204 or motions sensor 220, to generate a time stamp for a detected motion event. The time-stamped event may be stored in either or both of the memory units 202, 206.

Referring to FIG. 3, the lottery terminals 104 are operatively coupled to a lottery authority network 100, which includes a lottery authority host computer 122. A first group or network 102 of lottery terminal units 104 may be operatively coupled to a lottery network computer or server 106 via a network data link or bus 108. The lottery authority network 100 may be coupled to a communication network 110, which may be, for example, the Internet, a wide area network (WAN), or a local area network (LAN) through a network hub or router 112 via a first network link 114. In one possible configuration, the first network 102 may be a state lottery system operating within an individual state or region of states. In this configuration, the individual lottery terminal units 104 may be interconnected to a central system (e.g., host computer system 122 with central lottery controller 123) for tracking and coordination of the state lottery system, including issued tickets, drawn numbers, and/or amounts wagered.

The lottery authority network 100 may further include other lottery terminal units 116 that may be directly connected to the network 110 through a plurality of direct network links 118, thereby eliminating the need for the bus 108, router 112 or other networking equipment. Each lottery terminal unit 116 in this configuration may represent a group of lottery retailers participating in the state lottery, as described above, or a plurality of the lottery terminal units 116 may be grouped together to form a lottery node 120. The lottery nodes 120, in turn, may be directly connected and/or multiplexed to the network 110 via the direct network links 118. Further, the direct network links 118 may represent secure communications channels physically hardened against tampering and/or the communications may be encrypted to prevent unauthorized access to information transmitted thereon.

It will be understood that the lottery authority network 100 illustrated in FIG. 3 may alternatively represent the network layout within a given establishment. In this alternate configuration, each stand-alone lottery terminal unit 104 may be an interactive terminal capable of playing a variety of lottery or casino games, such as a lottery game, Keno, Bingo, video poker, video blackjack, slots, and the like. Terminal units 104 may be distributed throughout a single establishment and connected with a LAN, or throughout multiple sites and connected with a WAN. Further, the LAN and/or WAN connecting each of the terminal units 104 may include one or more separate and secure buses 108, routers 112, web servers, gateways and other networking equipment to provide continuous and/or redundant connectivity to the network 110. As discussed above, the network 110 may be communicatively connected to a central host computer 122 as well as associated databases to allow for implementation, storage, tracking and analysis of gaming and lottery features.

The terminal controller 200 and/or lottery authority (via the central lottery computer 122) may be configured to issue control commands for the lottery terminal 104 as a function of the magnitude of a detected motion event. This magnitude value may be, for example, a gravitational force (“G” force) associated with the time-stamped motion event. The G force value may be derived or calculated from the output signal of an accelerometer-based motion sensor. It should be appreciated that any proportional signal or value (e.g., a voltage value) may be used as a magnitude indicator.

A magnitude of a movement event above a certain threshold value may result in a shutdown of the terminal 104 until some sort of corrective action is taken or verification of the location of the terminal is ascertained. Other control functionalities may include initiation of a service call to a technician or other personnel to verify location of the lottery terminal 104, or a call to the retail establishment where the terminal 104 is located. The terminal controller 200 may generate and transmit to the lottery authority network 100 any combination of an alert signal, corrective action signal, or service call request based on detected motion of the lottery terminal.

In still other embodiments, the lottery terminal controllers 200 may simply forward information of the detected movement events to the lottery authority computer 122, which in turn analyzes the information and issues command signals back to the controller 200 related to any one or combination of corrective actions. The lottery authority computer 122 may also initiate responsive actions, such as a service call or communication to the retail establishment.

As depicted in the figures, it may be desirous to include a battery backup 230 for the motions sensor 220 and/or related command functions so that the functions cannot be overridden by disconnecting power from the lottery terminal prior to moving the terminal 104. Once power is restored to the terminal 104, the time-stamped movement events may be processed as discussed above.

The present invention also encompasses various embodiments of a lottery terminal system wherein a plurality of the lottery terminals 104 as discussed above are communicatively coupled to the lottery authority network 100. The lottery terminals 104 may include any combination of the features and aspects described above.

The material particularly shown and described above is not meant to be limiting, but instead serves to show and teach various exemplary implementations of the present subject matter. As set forth in the attached claims, the scope of the present invention includes both combinations and sub-combinations of various features discussed herein, along with such variations and modifications as would occur to a person of skill in the art.

What is claimed is:

1. A lottery terminal, comprising:
a housing;
a terminal controller configured within said housing for processing a player's request for a lottery ticket via an input device and issuing an authorized lottery ticket to the player via an output device;
a network interface for communicatively coupling said terminal controller to a lottery authority network;
a motion sensor operably configured within said housing to detect movement of said lottery terminal from a stationary position, said motion sensor configured with said terminal controller;
wherein said terminal controller is further configured to transmit a signal to the lottery authority network indicating movement of said lottery terminal beyond a threshold value.

2. The lottery terminal as in claim 1, wherein said motion sensor comprises an accelerometer device.

3. The lottery terminal as in claim 1, wherein said motion sensor further comprises a timing device configured to generate a time stamp for the detected movement of the lottery terminal, said terminal controller comprising memory for storing the time-stamped detection of movement of lottery terminal.

4. The lottery terminal as in claim 3, wherein said signal transmitted by said terminal controller to said lottery authority network includes the time-stamped detection of movement.

5. The lottery terminal as in claim 4, wherein said signal transmitted by said terminal controller to said lottery authority network includes a magnitude of the detected movement of said lottery terminal.

6. The lottery terminal as in claim 5, wherein said terminal controller is configured to provide a gravitational force (G force) loading for the detected movement of the lottery terminal over the time-stamped period.

7. The lottery terminal as in claim 1, wherein said terminal controller is configured to generate different command signals for said lottery terminal responsive to degrees of motion detected by said motion sensor.

8. The lottery terminal as in claim 7, wherein said terminal controller is configured to generate a shutdown command signal responsive to detected motion above a threshold value to disable said lottery terminal.

9. The lottery terminal as in claim 7, wherein said terminal controller is configured to generate and transmit to said lottery authority network any combination of an alert signal, corrective action signal, or service call request.

10. The lottery terminal as in claim 7, wherein said terminal controller communicates all said command signals to said lottery authority network.

11. The lottery terminal as in claim 1, wherein a lottery authority host computer associated with the lottery authority network generates and transmits to said terminal controller different command signals for said lottery terminal responsive to degrees of motion detected by said motion sensor.

12. The lottery terminal as in claim 11, wherein said command signals from said lottery authority host computer are any one or combination of a shutdown signal, alert signal, corrective action signal, or service call request.

13. The lottery terminal as in claim 1, further comprising a battery backup for powering said motion sensor functions upon loss of power to said terminal.

14. A lottery terminal system, comprising:
a plurality of lottery terminals, each of said lottery terminals comprising a housing and a terminal controller configured within said housing for processing a player's request for a lottery ticket via an input device and issuing an authorized lottery ticket to the player via an output device;
a lottery authority network, and a network interface for communicatively coupling said terminal controllers to said lottery authority network;
a motion sensor operably configured within each respective said housing to detect movement of said lottery terminal from a stationary position, said motion sensor configured with said terminal controller;
wherein said terminal controllers are further configured to transmit a signal to said lottery authority network indicating movement of said lottery terminal beyond a threshold value.

15. The lottery terminal system as in claim 14, wherein said motion sensors comprise an accelerometer device.

16. The lottery terminal system as in claim 14, wherein said motion sensor further comprises a timing device configured to generate a time stamp for the detected movement of said lottery terminal, said terminal controllers comprising memory for storing the time-stamped detection of movement of said lottery terminals, wherein said signal transmitted by said terminal controller to said lottery authority network includes the time-stamped detection of movement.

17. The lottery terminal system as in claim 16, wherein said signal transmitted by said terminal controller to said lottery authority network includes a magnitude of the detected movement of said lottery terminal.

18. The lottery terminal system as in claim 17, wherein said terminal controller is configured to provide a gravitational force loading (G force) for the detected movement of the lottery terminal over the time-stamped period.

19. The lottery terminal system as in claim 14, wherein said terminal controllers are configured to generate different command signals for said lottery terminal responsive to degrees of motion detected by said motion sensor, wherein said command signals include any one or combination of a shutdown command signal responsive to detected motion above a threshold value to disable said lottery terminal, an alert signal, a corrective action signal, or a service call request.

20. The lottery terminal system as in claim 14, wherein a lottery authority host computer associated with said lottery authority network generates and transmits to said terminal controllers different command signals for said lottery terminal responsive to degrees of motion detected by said motion sensor, wherein said command signals from said lottery authority network are any one or combination of a shutdown signal, alert signal, corrective action signal, or service call request.
